(19) United States
(12) Patent Application Publication
(10) Pub. No.: US 2024/0163980 A1
(43) Pub. Date: May 16, 2024

(54) HONEYCOMB STRUCTURE, INDUCTION HEATING DEVICE AND HONEYCOMB UNIT

(71) Applicant: NGK INSULATORS, LTD., Nagoya-City (JP)

(72) Inventors: Shuichi ICHIKAWA, Nagoya-Shi (JP); Takuya ISHIHARA, Tsushima-Shi (JP); Yukio MIYAIRI, Nagoya-Shi (JP)

(73) Assignee: NGK INSULATORS, LTD., Nagoya-City (JP)

(21) Appl. No.: 18/467,809

(22) Filed: Sep. 15, 2023

(30) Foreign Application Priority Data
Nov. 11, 2022 (JP) 2022-181398

(51) Int. Cl. H05B 6/36; H05B 6/10

(52) U.S. Cl. CPC H05B 6/365; H05B 6/106

(57) ABSTRACT

A honeycomb structure according to the present invention includes: a honeycomb structure portion 10 including an outer peripheral wall 100 and partition walls 101 arranged on an inner side of the outer peripheral wall 100, the partition walls 101 defining a plurality of cells 101a each forming a flow path extending one end face to other end face; and a magnetic material powder 11 attached to or filled in at least one of the plurality of cells 101a, wherein a volume and/or weight of the magnetic material powder 11 per unit volume varies in an axial direction AD and/or an axis orthogonal direction OD of the honeycomb structure portion 10.

### FIELD OF THE INVENTION

The present invention relates to a honeycomb structure, an induction heating device, and a honeycomb unit.

### BACKGROUND OF THE INVENTION

For example, as shown in Non-Patent Literature 1 below, induction heating is known to heat a heating object by electromagnetic induction. The induction heating is performed by placing an induction heating coil near a heating object containing magnetic and/or conductive materials and generating a magnetic field near the induction heating coil.

The induction heating coil can be formed by winding a conductor, such as a copper pipes and rectangular wire, around a predetermined axis. For example, when heating a pillar shaped heating object, the induction heating coil can be placed around the periphery of the heating object. A magnetic field can be generated by passing an electric current through the induction heating coil. The current flowing through the induction heating coil can be a large current obtained by amplifying alternating current from a high-frequency inverter with a transformer. The induction heating is particularly useful for heating materials with poor thermal conductivity and for heating objects under conditions where thermal contact is not easy, because the heating object can be heated without contact.

### CITATION LIST

### Non-Patent Literature

[Non-Patent Literature 1] JAPAN ELECTRO-HEAT CENTER (ed.), “Newly Revised Version: Electro-heat Handbook”, Ohmsha, Ltd., Apr. 10, 2019 (p. 263)

### SUMMARY OF THE INVENTION

When the heating object is placed in the induction heating coil as described above, the magnetic flux tends to concentrate on the outer peripheral portion of the heating object close to the induction heating coil, and an unintended temperature deviation tends to occur between the outer peripheral portion and the center of the heating object in the axis orthogonal direction. There is also a need to intentionally generate the temperature deviation in the axial and/or axis orthogonal direction, but the conventional configuration is not intended to meet such a need.

The present invention was made to solve the above problems. One of the objects of the present invention is to provide a honeycomb structure, an induction heating device, and a honeycomb unit, which can adjust a temperature in an axial direction and/or an axis orthogonal direction during induction heating.

### Aspect 1.

In an embodiment, the present invention relates to a honeycomb structure comprising: a honeycomb structure portion comprising an outer peripheral wall and partition walls arranged on an inner side of the outer peripheral wall, the partition walls defining a plurality of cells each forming a flow path extending one end face to other end face; and a magnetic material powder attached to or filled in at least one of the plurality of cells, wherein a volume and/or weight of the magnetic material powder per unit volume vary in an axial direction and/or an axis orthogonal direction of the honeycomb structure portion.

### Aspect 2.

The present invention may relate to the honeycomb structure according to Aspect 1, wherein the plurality of cells comprise a plurality of magnetic cells having the magnetic material powder filled in the cells or having the magnetic material powder attached to the partition walls, and wherein the honeycomb structure portion has a plurality of regions which are arranged coaxially with each other and have different ratios of the magnetic cells present from each other, at the end face or in a cross section orthogonal to the axial direction.

### Aspect 3

The present invention may relate to the honeycomb structure according to Aspect 2, wherein the axis orthogonal direction comprises first and second directions that intersect with each other, and the cells having a certain number, adjacent to each other, comprise cell blocks each including X cells each in the first and second directions, where X is any positive number, and wherein the magnetic cells included in the cell blocks having the same size have different numbers from each other between the plurality of regions.

### Aspect 4.

The present invention may relate to the honeycomb structure according to Aspect 2, wherein the axis orthogonal direction comprises first and second directions that intersect with each other, and wherein the cells having a certain number, adjacent to each other, comprise cell blocks each including X cells each in the first and second directions, where X is any positive number, and the cell blocks each including one magnetic cell have different sizes from each other between the plurality of regions.

### Aspect 5.

The present invention may relate to the honeycomb structure according to any one of Aspects 2 to 4, wherein the honeycomb structure portion comprises: a central region including an axial center of the honeycomb structure portion; and an outer peripheral region adjacent to the outer peripheral wall, wherein a ratio of the magnetic cells present in the central region is larger than that of the magnetic cells present in the outer peripheral region.

### Aspect 6.

The present invention may relate to the honeycomb structure according to any one of Aspects 1 to 5, wherein the plurality of cells comprise a plurality of magnetic cells having the magnetic material powder filled in the cells or having the magnetic material powder attached to the partition walls, and wherein the honeycomb structure portion has a plurality of regions which are arranged coaxially with each other and have different numbers of the magnetic cells per unit area from each other, at the end face or in the cross section orthogonal to the axial direction.

### Aspect 7.

The present invention may relate to the honeycomb structure according to Aspect 6, wherein the magnetic cells adjacent to each other have different numbers between the plurality of regions.

### Aspect 8.

The present invention may relate to the honeycomb structure according to Aspect 6 or 7, wherein the honeycomb structure portion comprises: a central region including an axial center of the honeycomb structure portion; and an outer peripheral region adjacent to the outer peripheral wall, and wherein the number of the magnetic cells per unit area in the central region is larger than that of the magnetic cells per unit area in the outer peripheral region.

### Aspect 9.

The present invention may relate to the honeycomb structure according to any one of Aspects 1 to 8, wherein the plurality of cells comprise a plurality of magnetic cells having the magnetic material powder filled in the cells, and wherein the honeycomb structure portion has the end faces axially spaced from each other or cross sections orthogonal to the axial direction, the end faces or the cross sections having different ratios of the magnetic cells present or different numbers of the magnetic cells per unit area from each other.

### Aspect 10.

The present invention may relate to the honeycomb structure according to any one of Aspects 1 to 9, wherein the plurality of cells comprise a plurality of magnetic cells having the magnetic material powder filled in the cells, and wherein the honeycomb structure portion has a plurality of regions which are arranged coaxially with each other and have different filling rates of the magnetic material powder in the magnetic cells from each other, at the end face or in the cross section orthogonal to the axial direction.

### Aspect 11.

The present invention may relate to the honeycomb structure according to Aspect 10, wherein the honeycomb structure portion comprises: a central region including an axial center of the honeycomb structure portion; and an outer peripheral region adjacent to the outer peripheral wall, and wherein the filling rate of the magnetic material powder in the central region is higher than that of the magnetic material powder in the outer peripheral region.

### Aspect 12.

The present invention may relate to the honeycomb structure according to Aspect 11, wherein a difference between the filling rates in the central region and the outer peripheral region is 10% or more.

### Aspect 13.

The present invention may relate to the honeycomb structure according to any one of Aspects 1 to 12, wherein the plurality of cells comprise a plurality of magnetic cells having the magnetic material powder filled in the cells, and wherein the honeycomb structure portion has the end faces axially spaced from each other or cross sections orthogonal to the axial direction, the end faces or the cross sections having different filling rates of the magnetic material powder in the magnetic cells from each other.

### Aspect 14.

The present invention may relate to the honeycomb structure according to Aspect 13, wherein the filling rate of the magnetic material powder on the one end face side of the honeycomb structure portion is higher than that of the magnetic material powder on the other end face side.

### Aspect 15.

In an embodiment, the present invention relates to a honeycomb structure comprising: a honeycomb structure portion having an outer peripheral wall and partition walls arranged on an inner side of the outer peripheral wall, the partition walls defining a plurality of cells each forming a flow path extending from one end face to other end face; and a magnetic material powder attached to or filled in at least one of the plurality of cells, wherein the magnetic material powder comprises multiple magnetic material powders having different magnetic permeabilities, and wherein a ratio of the multiple magnetic material powders used varies in an axial direction and/or an axis orthogonal direction of the honeycomb structure portion.

### Aspect 16.

The present invention may relate to the honeycomb structure according to Aspect 15, wherein the honeycomb structure portion comprise: a central region including an axial center of the honeycomb structure portion; and an outer peripheral region adjacent to the outer peripheral wall at the end face or in a cross section orthogonal to the axial direction, and wherein the magnetic material powder in the central region has a larger magnetic permeability than that of the magnetic material powder in the outer peripheral region.

### Aspect 17.

The present invention may relate to the honeycomb structure according to Aspect 16, wherein a difference between the magnetic permeabilities of the magnetic material powders in the central region and the outer peripheral region is 1000 or more.

### Aspect 18.

In one embodiment, the invention relates to a honeycomb unit comprising: a plurality of honeycomb structures, each having an outer peripheral wall and partition walls arranged on an inner side of the outer peripheral wall, the partition walls defining a plurality of cells each forming a flow path extending from one end face to other end face, the honeycomb structures being arranged side by side in respective axial directions and/or axis orthogonal directions; and a magnetic material powder attached to or filled in at least one of the plurality of cells in at least one of the honeycomb structures, wherein a volume and/or weight of the magnetic material powder per unit volume vary in the axial direction and/or the axis orthogonal direction of the honeycomb unit.

### Aspect 19.

In one embodiment, the invention relates to a honeycomb unit comprising: a plurality of honeycomb structures, each having an outer peripheral wall and partition walls arranged on an inner side of the outer peripheral wall, the partition walls defining a plurality of cells each forming a flow path extending from one end face to other end face, the honeycomb structures being arranged side by side in respective axial directions and/or axis orthogonal directions; and a magnetic material powder attached to or filled in at least one of the plurality of cells in at least one of the honeycomb structures, wherein the magnetic material powder comprises multiple magnetic material powders having different magnetic permeabilities, and wherein a ratio of the multiple magnetic material powders used varies in the axial direction and/or the axis orthogonal direction of the honeycomb unit.

### Aspect 20.

The present invention may relate to the honeycomb unit according to Aspect 18 or 19, wherein a magnetic body or metal is disposed between the honeycomb structures.

### Aspect 21.

In one embodiment, the present invention relates to an induction heating device, comprising: the honeycomb structure according to any one of Aspects 1 to 17 or the honeycomb unit according to any one of Aspects 18 to 20; and an induction heating coil arranged around an outer periphery of the honeycomb structure or the honeycomb unit, the induction heating coil heating the honeycomb structure or the honeycomb unit by induction heating.

According to the honeycomb structure and induction heating device of the present invention, the temperature in the axial direction and/or axis orthogonal direction during induction heating can be adjusted because the volume and/or weight of the magnetic material powder per unit volume or the ratio of multiple magnetic material powders used vary in the axial direction and/or the axis orthogonal direction of the honeycomb structure portion.

Also, according to the honeycomb unit of the present invention, the temperature in the axial direction and/or axis orthogonal direction during induction heating can be adjusted because the volume and/or weight of the magnetic material powder per unit volume or the ratio of multiple magnetic material powders used vary in the axial direction and/or the axis orthogonal direction of the honeycomb unit.

### BRIEF DESCRIPTION OF THE DRAWINGS

FIG. 1 is a perspective view showing an induction heating device having a honeycomb structure according to Embodiment 1 of the present invention;

FIG. 2 is a circuit view showing an example of the power supply circuit in FIG. 1;

FIGS. 3A and 3B are explanatory views showing a first mode of arrangement of magnetic cells in an end face of the honeycomb structure portion in FIG. 1 or in a cross section orthogonal to an axial direction AD;

FIGS. 4A-4C are explanatory views showing a second mode of arrangement of magnetic cells at an end face or in a cross section orthogonal to an axial direction AD of the honeycomb structure portion in FIG. 1;

FIG. 5 is an explanatory view showing a first mode of region arrangement at an end face or in a cross section orthogonal to an axial direction AD of the honeycomb structure portion in FIG. 1;

FIG. 6 is an explanatory view showing a second mode of region arrangement region arrangement at an end face or in a cross section orthogonal to an axial direction AD of the honeycomb structure portion in FIG. 1;

FIG. 7 is an explanatory view showing a first mode where the arrangement of magnetic cells is changed in an axial direction AD of a honeycomb structure in FIG. 1;

FIG. 8 is an explanatory view conceptually showing the arrangement of the magnetic cells in FIG. 7;

FIG. 9 is an explanatory view showing a first mode where the arrangement of magnetic cells changes in an axis orthogonal direction OD and an axial direction AD of the honeycomb structure of FIG. 1;

FIG. 10 is an explanatory view showing a second mode where the arrangement of magnetic cells changes in an axis orthogonal direction OD and an axial direction AD of the honeycomb structure in FIG. 1;

FIGS. 11A and 11B are explanatory views showing a main part of a honeycomb structure according to Embodiment 2 of the present invention;

FIG. 12 is a perspective view showing an induction heating device provided with a honeycomb unit according to Embodiment 4 of the present invention;

FIG. 13 is a perspective view of the central honeycomb structure in FIG. 12; and

FIG. 14 is a perspective view showing the outer peripheral honeycomb structure in FIG. 12.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

### Embodiment 1

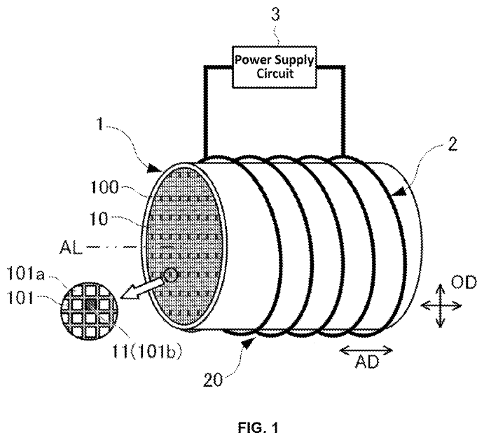

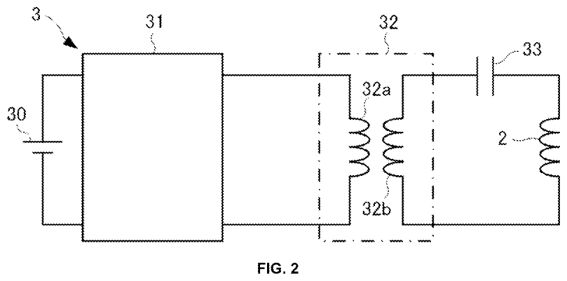

FIG. 1 is a perspective view showing an induction heating device having a honeycomb structure according to Embodiment 1 of the present invention, and FIG. 2 is a circuit view showing an example of the power supply circuit in FIG. 1. The induction heating device shown in FIG. 1 is a device configured to be able to heat a honeycomb structure 1 by induction heating. The induction heating device according to this embodiment has a honeycomb structure 1, an induction heating coil 2 and a power supply circuit 3.

The honeycomb structure 1 has a honeycomb structure portion 10 and magnetic material powder 11.

The honeycomb structure portion 10 has an outer peripheral wall 100 and partition walls 101 that are arranged on an inner side of the outer peripheral wall 100 and define a plurality of cells 101a each forming a flow path extending from one end face to the other end face. The outer shape of the honeycomb structure portion 10 may be pillar shaped. It is understood that the pillar shape is a three-dimensional shape having a thickness in an axial direction (AD). The axial direction may be an extending direction of the cells 101a. A ratio of a length of the honeycomb structure portion 10 in the axial direction to a diameter or width of the end face of the honeycomb structure portion 10 (aspect ratio) is arbitrary. The pillar shape may also include a shape in which the length of the honeycomb structure portion 10 in the axial direction is shorter than the diameter or width of the end face (flat shape). The outer shape of the honeycomb structure portion 10 may be, but not limited to, a pillar shape having circular end faces (cylindrical shape) as shown in FIG. 1, a pillar shape having oval end faces, and a pillar shape having polygonal (rectangular, pentagonal, hexagonal, heptagonal, octagonal, etc.) end faces.

The materials of the outer peripheral wall 100 and the partition walls 101 are not limited, but they are typically formed of ceramic materials. Examples of the ceramics include cordierite, silicon carbide, aluminum titanate, silicon nitride, mullite, alumina, silica, silicon-silicon carbide-based composite materials, silicon carbide-cordierite-based composite materials, especially a sintered body mainly based on silicon-silicon carbide composite material or silicon carbide. As used herein, “silicon carbide-based” means that the outer peripheral wall 100 and the partition walls 101 contain 50% by mass of silicon carbide based on the total of the outer peripheral wall 100 and the partition walls 101. The phrase “the outer peripheral wall 100 and the partition walls 101 are mainly based on silicon-silicon carbide composite material” means that the outer peripheral wall 100 and the partition walls 101 contain 90% by mass of more of silicon-silicon carbide composite material (total mass) based on the total of the outer peripheral wall 100 and the partition walls 101. Here, for the silicon-silicon carbide composite material, it contains silicon carbide particles as an aggregate and silicon as a binding material to bind the silicon carbide particles, and preferably a plurality of silicon carbide particles are bound by silicon such that pores are formed between the silicon carbide particles. The phrase “the outer peripheral wall 100 and the partition walls 101 are mainly based on silicon carbide” means that the outer peripheral wall 100 and the partition walls 101 contain 90% or more of silicon carbide (total mass) based on the total of the outer peripheral wall 100 and the partition walls 101.

Preferably, the outer peripheral wall 100 and the partition walls 101 are made of at least one ceramic material selected from the group consisting of cordierite, silicon carbide, silicon-silicon carbide composite materials, aluminum titanate, silicon nitride, mullite, silica, and alumina.

The shape of each cell 101a is not particularly limited, but it may preferably be polygonal such as triangular, quadrangular, pentagonal, hexagonal, and octagonal, circular, or oval, in the cross section orthogonal to the central axis of honeycomb structure 1, or it may be irregularly shaped. Preferably, it is polygonal.

The thickness of the partition wall 101 is preferably 0.05 to 0.50 mm, and more preferably 0.10 to 0.45 mm, in terms of ease of production. For example, when it is 0.05 mm or more, the strength of the honeycomb structure 1 can be further improved, and when it is 0.50 mm or less, pressure loss can be reduced. The thickness of the partition wall 101 is an average value measured by microscopic observation of the cross section in the central axis direction.

The partition walls 101 preferably have a porosity of 20 to 70%. The porosity of the partition walls 101 is preferably 20% or more in terms of ease of production, and when it is 70% or less, the strength of the honeycomb structure 1 can be maintained.

The partition walls 101 preferably have an average pore diameter of 2 to 30 μm, and more preferably 5 to 25 μm. The average pore diameter of the partition walls 101 of 2 μm or more leads to easy production, and the average pore diameter of 30 μm or less allows the strength of the honeycomb structure 1 to be maintained. As used herein, the terms “average pore diameter” and “porosity” mean an average pore diameter and porosity measured by mercury intrusion technique.

The density of the cells 101a is not particularly limited, but it may preferably be in the range of 5 to 150 cells/cm², and more preferably in the range of 5 to 100 cells/cm², and even more preferably in the range of 31 to 80 cells/cm².

The honeycomb structure 1 is produced by forming a green body containing ceramic raw materials into a honeycomb shape having partition walls 101 extending from one end face to the other to form a plurality of cells 101a that serve as fluid flow paths to form a honeycomb formed body, and then firing the honeycomb formed body after drying it. When the resulting honeycomb structure 1 is used for the honeycomb structure 1, the outer peripheral wall 100 may be extruded integrally with the honeycomb structure 1 and used as it is as the outer peripheral wall 100, or the outer periphery of the honeycomb structure 1 may be ground to a predetermined shape after forming or firing, and the honeycomb structure from which the outer periphery has been ground is coated with a coating material to form an outer peripheral coating. In this embodiment, for example, the honeycomb structure 1 with the outer periphery may be used without grinding the outermost periphery of the honeycomb structure 1, and the outer peripheral surface of the honeycomb structure 1 with that outer periphery (i.e., further outer side of the outer periphery of the honeycomb structure 1) may be further coated with the above coating material to form an outer peripheral coating. The former case will result in an outer peripheral wall 100 in which only the outer peripheral coating comprised of the coating material is located the outermost periphery for the outer peripheral surface of the honeycomb structure 1. On the other hand, the latter case will result in formation of a two-layered outer peripheral wall 100 which is located in the outermost periphery and in which the outer peripheral coating consisting of the coating material is further laminated onto the outer peripheral surface of the honeycomb structure 1. The outer peripheral wall 100 may be extruded integrally with the honeycomb structure portion 10 and fired as it is, and may be used as the outer peripheral wall 100 without any processing of the outer periphery.

The honeycomb structure 1 is not limited to an integrated honeycomb structure 1 with which the partition walls 101 are integrally formed. It may be, for example, a honeycomb structure 1 (joined honeycomb structure) having a structure where a plurality of pillar shaped honeycomb segments each having ceramic partition walls 101 and a plurality of cells 101a defined by the partition walls 101 to form fluid flow paths are combined via joining material layers.

The magnetic material powder 11 is attached to or filled in at least one of the plurality of cells 101a. The magnetic material powder 11 may form coating layers provided on the surfaces of the partition walls 101, or may be filled in the cells 101a to form plugged portions that plugs the end portions or the entirety of the cells 101a. FIG. 1 shows a mode where the magnetic material powder 11 forms plugged portions.

When the magnetic material powder 11 forms the coating layer, the coating layer may include a fixing material in which the magnetic material powder 11 is dispersed. Examples of the fixing material that can be used herein include glass containing silicate, borate or borosilicate, crystallized glass, and ceramics, or glass, crystallized glass, ceramics, and the like, which contain other oxides.

When the magnetic material powder 11 forms the plugged portions, the magnetic material powder 11 may have a pillar outer shape matching the shape of the cells 101a. The magnetic material powder 11 may have such an outer shape before being filled in the cells 101a, or may have such an outer shape as a result of being filled in the cells 101a. In other words, the magnetic material powder 11 may form a fixed-shaped material having a predetermined shape, or may form a paste-like irregular-shaped material.

The fixed-shaped material and irregular-shaped material may be composed of a composition in which the magnetic material powder 11 and a binding material or an adhesive material are combined. Examples of the binding material include materials based on a metal or glass. The adhesive material includes materials based on silica or alumina. In addition to the binding material or adhesive material, it may further contain an organic or inorganic substance. The magnetic material powder 11 may be filled from one end surface to the other end surface over the entire honeycomb structure 1. Further, the magnetic material powder 11 may be filled from one end face of the honeycomb structure 1 to the middle of the cells 101a.

The types of the magnetic material making up the magnetic material powder 11 are, for example, the balance Co-20% by mass of Fe; the balance Co-25% by mass of Ni-4% by mass of Fe; the balance Fe-15 to 35% by mass of Co; the balance Fe-17 Co-2% by mass of Cr-1% by mass of Mo; the balance Fe-49% by mass of Co-2% by mass of V; the balance Fe-18% by mass of Co-10% by mass of Cr-2% by mass of Mo-1% by mass of Al; the balance Fe-27% by mass of Co-1% by mass of Nb; the balance Fe-20% by mass of Co-1% by mass of Cr-2% by mass of V; the balance Fe-35% by mass of Co-1% by mass of Cr; pure cobalt; pure iron; electromagnetic soft iron; the balance Fe-0.1 to 0.5% by mass of Mn; the balance Fe-3% by mass of Si; the balance Fe-6.5% by mass of Si; the balance Fe-18% by mass of Cr; the balance Fe-16% by mass of Cr-8% by mass of Al; the balance Ni-13% by mass of Fe-5.3% by mass of Mo; the balance Fe-45% by mass of Ni; the balance Fe-10% by mass of Si-5% by mass of Al; the balance Fe-36% by mass of Ni; the balance Fe-45% by mass of Ni; the balance Fe-35% by mass of Cr; the balance Fe-13% by mass of Cr-2% by mass of Si; the balance Fe-20% by mass of Cr-2% by mass of Si-2% by mass of Mo; the balance Fe-20% by mass of Co-1% by mass of V; the balance Fe-13% by mass of Cr-2% by mass of Si; the balance Fe-17% by mass of Co-2% by mass of Cr-1% by mass of Mo, and the like.

The induction heating coil 2 is formed by winding a conductor 20 around a predetermined axis line AL. The induction heating coil 2 is arranged on the outer periphery of the honeycomb structure 1. The axis line AL of the induction heating coil 2 can be parallel to the axial direction AD of the honeycomb structure 1. The axis line AL may be coaxial with the central axis of the honeycomb structure 1.

The induction heating coil 2 is connected to a power supply circuit 3. As shown in FIG. 2, the power supply circuit 3 can include a DC power supply 30, an inverter 31, a transformer 32 and a resonance capacitor 33. DC power from the DC power supply 30 is converted into AC power by the inverter 31. The transformer 32 has a primary coil 32a connected to the inverter 31 and a secondary coil 32b connected to the resonance capacitor 33 and to the induction heating coil 2. A turn ratio of the primary coil 32a and the secondary coil 32b is N:1. The symbol N is a number greater than 1, and the transformer 32 can amplify the current of AC power. The capacity of the resonance capacitor 33 is set so as to adjust the resonance frequency of the power supply circuit 3. The induction heating coil 2 can be connected in series with the resonance capacitor 33 and can be connected to both ends of the secondary coil 32b together with the resonance capacitor 33.

The AC current is supplied from the power circuit 3 to the induction heating coil 2, a magnetic flux is generated in the vicinity of the induction heating coil 2. The honeycomb structure 1 can be inductively heated by the magnetic flux from the induction heating coil 2.

Generally, the magnetic flux from the induction heating coil 2 tends to concentrate on the outer peripheral portion of the honeycomb structure 1 near the induction heating coil 2, and an unintentional temperature deviation is easily generated between the outer peripheral portion and the central portion of the honeycomb structure 1 in the axis orthogonal direction OD. There is also a need for intentionally generating the temperature deviation in the axial direction AD and/or axis orthogonal direction OD during induction heating, but it has been difficult to intentionally generate such a temperature deviation.

The honeycomb structure 1 according to this embodiment is configured so that the volume and/or weight of the magnetic material powder 11 per unit volume vary in the axial direction AD and/or the axis orthogonal direction OD of the honeycomb structure portion 10. The magnetic flux from the induction heating coil 2 is more induced at a position where the volume and/or weight of the magnetic material powder 11 per unit volume is larger, i.e., where the magnetic permeability is larger. The distribution of the magnetic flux can be arbitrarily designed by the distribution of the magnetic material powder 11, and the temperature of the honeycomb structure 1 in the axial direction AD and/or axis orthogonal direction OD during induction heating can be adjusted. In other words, the honeycomb structure 1 according to this embodiment can make the temperature distribution of the honeycomb structure 1 uniform, and also create the intentional temperature deviation.

Hereinafter, the mode of distribution of the magnetic material powder 11 will be described in more detail. Among the plurality of cells 101a, the cells 101a filled with the magnetic material powder 11 or having the magnetic material powder 11 attached to the partition walls 101 is referred to as magnetic cells 101b. That is, the plurality of cells 101a include a plurality of magnetic cells 101b. Moreover, one cell has any size, and has a shape that is not limited to a quadrangle and can be arbitrarily changed to, for example, a triangle, a pentagon, a hexagon, an octagon, or the like.

The honeycomb structure 1 according to this embodiment may have a plurality of regions which are arranged coaxially with each other and which have different ratios of the magnetic cells 101b present from each other, at the end face or in the cross section orthogonal to the axial direction AD. By providing such regions, the volume and/or weight of the magnetic material powder 11 per unit volume at the end face or in the cross section orthogonal to the axial direction AD can be adjusted, and the temperature of the honeycomb structure 1 during induction heating in the axis orthogonal direction OD can be adjusted.

As described above, more magnetic flux is induced at the portion where the volume and/or weight of the magnetic material powder 11 per unit volume is larger. Therefore, the ratio of the magnetic cells 101b present can be relatively larger in the region where the temperature is to be increased. The ratio of the magnetic cells 101b present can be calculated based on the number of magnetic cells 101b having a certain number of cells 101a, adjacent to each other. It can also be expressed as “a ratio of magnetic cells 101b”=“number of magnetic cells 101b”/“number of cells 101a”. Here, “the number of cells 101a” is the number including the number of cells 101a in which the magnetic material powder 11 is neither filled nor attached.

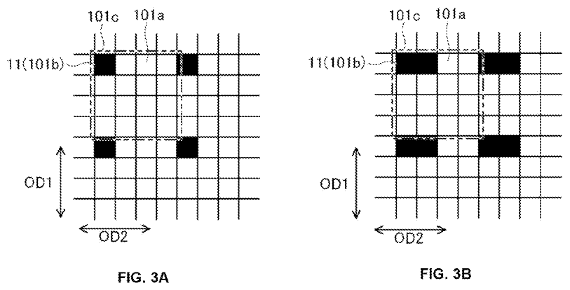

Next, FIGS. 3A and 3B are explanatory views showing a first mode of arrangement of the magnetic cells 101b at the end face or in the cross section orthogonal to the axial direction AD of the honeycomb structure portion 10 in FIG. 1. Any method can be used to adjust the ratio of the magnetic cells 101b present. For example, the arrangement of the magnetic cells 101b shown in FIGS. 3A and 3B can be used. As shown in FIGS. 3A and 3B, the axis orthogonal direction OD of the honeycomb structure 1 includes first and second directions OD1, OD2 that intersect with each other. The first and second directions OD1, OD2 are directions from the center position of the cell 101a to two different partition walls 101 forming the cell 101a. More specifically, the first and second directions OD1, OD2 may be directions passing through the central position of the cell 101a and the width central positions of the two different partition walls 101 forming that cell 101a. The width of the partition wall 101 may be understood as a distance between intersections of the partition walls 101. When the cells 101a are square as in the illustrated embodiment, the first and second directions OD1, OD2 may be directions orthogonal to each other. A predetermined number of cells 101a adjacent to each other may form cell blocks 101c each including X cells 101a where X is any positive number, each in the first and second directions OD1, OD2. The number of the magnetic cells 101b included in the cell blocks 101c having the same size may be different between regions having different ratios of the magnetic cells 101b present. By varying the number of magnetic cells 101b included in the cell blocks 101c having the same size, the ratio of the magnetic cells 101b present can be easily adjusted.

In FIGS. 3A and 3B, four cells 101a in the first and second directions OD1, OD2 form each cell block 101c. One magnetic cell 101b is included in one cell block 101c in FIG. 3A, and two magnetic cells 101b are included in one cell block 101c in FIG. 3B. In the arrangement mode as shown in FIG. 3A, the ratio of the magnetic cells 101b present is 1/16, and in the arrangement mode as shown in FIG. 3B, the ratio of the magnetic cells 101b present is 1/8.

The cell block 101c may include three or more magnetic cells 101b. As shown in FIG. 3B, a plurality of magnetic cells 101b may be adjacent to each other, or a single cell block 101c may include a plurality of magnetic cells 101b spaced apart from each other.

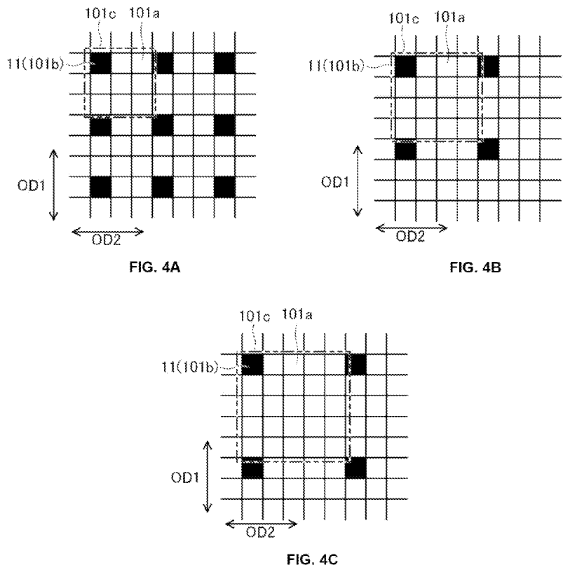

Next, FIGS. 4A-4C are explanatory views showing a second mode of arrangement of the magnetic cells 101b at the end face or in the cross section orthogonal to the axial direction AD of the honeycomb structure portion 10 in FIG. 1. For the ratio of the magnetic cells 101b present, for example, the arrangement of the magnetic cells 101b as shown in FIGS. 4A-4C may be used. In other words, the sizes of the cell blocks 101c each including one magnetic cell 101b may be different from each other between the regions where the ratios of the magnetic cells 101b present are different. By varying the sizes of the cell blocks 101c each including one magnetic cell 101b, the ratio of the magnetic cells 101b present can be easily adjusted.

FIG. 4A shows a mode where one magnetic cell 101b is included in each cell block 101c including three cells 101a in each of the first and second directions OD1, OD2 (a mode where the ratio of the magnetic cells 101b present is 1/9). FIG. 4B shows a mode where one magnetic cell 101b is included in each cell block 101c including four cells 101a in each of the first and second directions OD1, OD2 (a mode where the ratio of the magnetic cell 101b present is 1/16). FIG. 4C shows a mode where one magnetic cell 101b is included in each cell block 101c including five cells 101a in each of the first and second directions OD1, OD2 (a mode where the ratio of the magnetic cell 101b is 1/25). One magnetic cell 101b may be included in a smaller or larger cell block 101c (the ratio of the magnetic cell 101b present may be larger than 1/9 or smaller than 1/25).

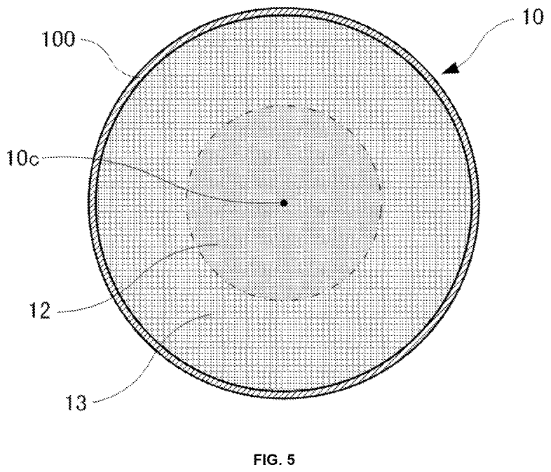

Next, FIG. 5 is an explanatory view showing a first mode of region arrangement at the end face or in the cross section orthogonal to the axial direction AD of the honeycomb structure portion 10 in FIG. 1. As shown in FIG. 5, the honeycomb structure portion 10 can include a central region 12 including an axial center 10c of the honeycomb structure portion 10 and an outer peripheral region 13 adjacent to the outer peripheral wall 100. The ratio of the magnetic cells 101b present in the central region 12 may be greater than that of the magnetic cells 101b present in the outer peripheral region 13, although not particularly limited thereto. This mode is particularly useful when it is desired to induce more magnetic flux into the central region 12 and increase the temperature of the central region 12. For example, the mode of arrangement of the magnetic cells 101b in the central region 12 is the mode as shown in FIG. 3B or FIG. 4A, and the mode of arrangement of the magnetic cells 101b in the outer peripheral region 13 may be the mode as shown in FIG. 3A or FIG. 4B.

The ratio of the magnetic cells 101b present in the central region 12 may be larger by 20% or more than that of the magnetic cells 101b present in the outer peripheral region 13.

The diameter of the central region 12 may be 10% or more and 90% or less, preferably 25% or more and 75% or less, more preferably 40% or more and 60% or less, of the diameter of the honeycomb structure portion 10. The width of the outer peripheral region 13 in the axis orthogonal direction OD (width of one side) may be 10% or more and 90% or less, preferably 25% or more and 75% or less, more preferably 40% or more and 60% or less, of the diameter of the honeycomb structure portion 10.

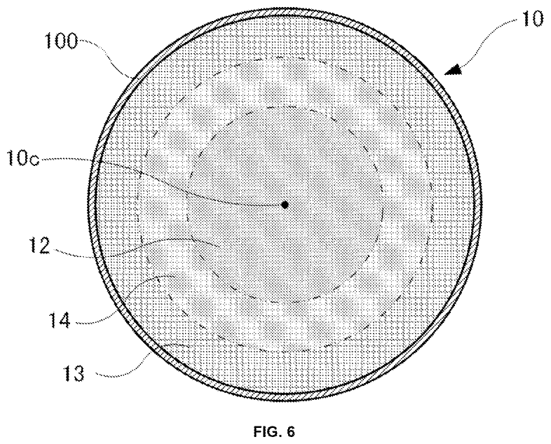

Next, FIG. 6 is an explanatory view showing a second mode of region arrangement at the end face or in the cross section orthogonal to axial direction AD of the honeycomb structure portion 10 in FIG. 1. As shown in FIG. 6, the honeycomb structure portion 10 may include at least one intermediate region 14 between the central region 12 and the outer peripheral region 13. The ratio of the magnetic cells 101b present in at least one intermediate region 14 may be smaller than that of the magnetic cells 101b present in the central region 12 and larger than that of the magnetic cells 101b present in the outer peripheral region 13. When two or more intermediate regions 14 are provided, the ratio of the magnetic cells 101b present in the inner intermediate regions 14 may be greater than that of the magnetic cells 101b in the outer intermediate region 14.

The width (width of one side) of the intermediate region 14 in the axis orthogonal direction OD may be 10% or more and 80% or less, preferably 10% or more and 60% or less, more preferably 10% or more and 40% or less of the diameter of the honeycomb structure portion 10.

The ratio of the magnetic cells 101b present can be arbitrarily changed, and if necessary, the ratio of the magnetic cells 101b present in the inner region (for example, the central region 12) may be smaller than that of the magnetic cells 101b present in the outer region (for example, the outer peripheral region 13 or the intermediate region 14). The ratio of the magnetic cells 101b present in the intermediate region 14 may be larger or smaller than in both the central region 12 and the outer peripheral region 13.

Although the honeycomb structure 1 according to the present embodiment has been described above based on the ratio of the magnetic cells 101b present, the honeycomb structure 1 according to the present embodiment can also be understood from another viewpoint as follows:

That is, the honeycomb structure portion 10 may have a plurality of regions which are arranged coaxially with each other and have different numbers of magnetic cells 101b per unit area at the end face or in the cross section orthogonal to the axial direction AD. The number of the magnetic cells 101b per unit area can be determined, for example, from the number of the magnetic cells 101b per square of any plurality of cells.

Also, the number of magnetic cells 101b adjacent to each other may vary between the plurality of regions. That is, one magnetic cell 101b may be spaced apart in one region as shown in FIG. 3A, and two magnetic cells 101b may be arranged so as to be adjacent to each other in the other region as shown in FIG. 3B. More magnetic cells 101b may be arranged so as to be adjacent to one another.

Also, the number of the magnetic cells 101b per unit area in the central region 12 may be larger than that of the magnetic cells 101b per unit area in the outer peripheral region 13.

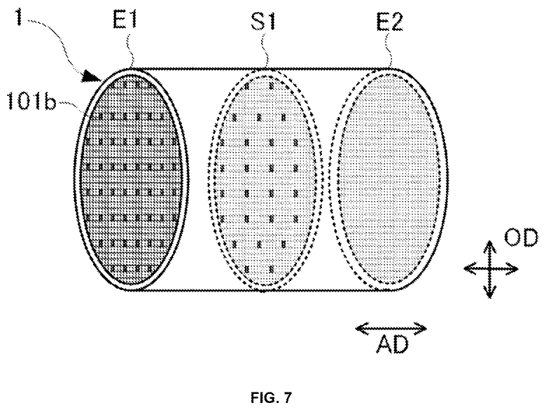

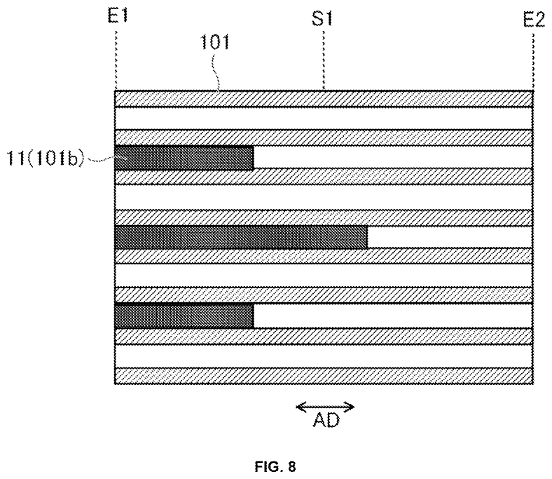

Next, FIG. 7 is an explanatory view showing changes in arrangement of the magnetic cells 101b in the axial direction AD of the honeycomb structure portion 10 in FIG. 1, and FIG. 8 is an explanatory view conceptually showing the arrangement of the magnetic cells 101b in FIG. 7. The honeycomb structure portion 10 may have end faces spaced apart from each other in the axial direction AD or a plurality of cross sections orthogonal to the axial direction AD, which differ from each other in the ratio of the magnetic cells 101b present or the number of the magnetic cells 101b per unit area. Hereinafter, “the ratio of the magnetic cells 101b present or the number of the magnetic cells 101b per unit area” may be referred to as “the ratio of the magnetic cells 101b present or the like”.

FIG. 7 shows a state where the ratio of the magnetic cells 101b present or the like at one end face E1 is larger than the ratio of the magnetic cells 101b present or the like in a cross section S1 at an intermediate position in the axial direction AD. FIG. 7 also shows a state where the ratio of the magnetic cells 101b present or the like in the cross section S1 at the intermediate position in the axial direction AD is larger than the ratio of the magnetic cells 101b present or the like at other end face E2. That is, the ratio of the magnetic cells 101b present or the like on the one end face E1 side may be larger than the ratio of the magnetic cells 101b present or the like on the other end face E2 side. By providing such an end face or cross section, the volume and/or weight of the magnetic material powder 11 per unit volume in the axial direction AD can be adjusted, and the temperature of the honeycomb structure 1 during induction heating in the axial direction AD can be adjusted.

The arrangement as shown in FIG. 7 can be achieved by the arrangement of the magnetic cells 101b as shown in FIG. 8. That is, as shown in FIG. 8, the arrangement as shown in FIG. 7 can be achieved such that some of the magnetic cells 101b present at one end surface E1 do not reach the intermediate position, and the magnetic cells 101b that have reached the intermediate position do not reach the other end surface E2. Although in FIGS. 7 and 8, the magnetic cells 101b are not provided at the other end surface E2, the magnetic cells 101b may be provided at the other end surface E2.

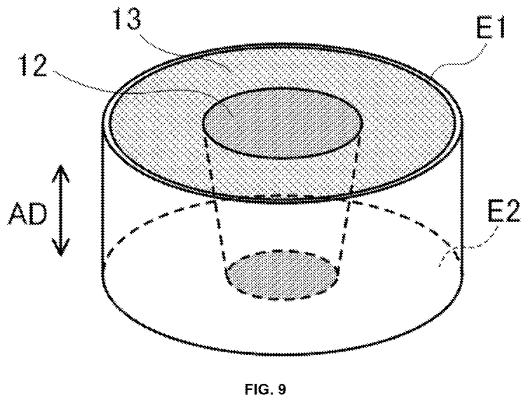

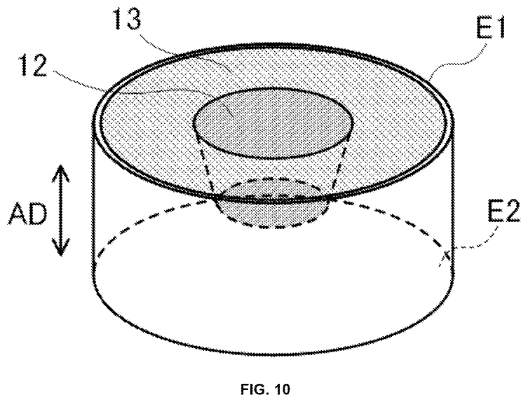

Next, FIG. 9 is an explanatory view showing a first mode where the arrangement of the magnetic cells 101b changes in the axis orthogonal direction OD and the axial direction AD of the honeycomb structure 1 in FIG. 1, and FIG. 10 is an explanatory view showing a second mode where the arrangement of the magnetic cells 101b changes in the axis orthogonal direction OD and the axial direction AD of the honeycomb structure 1 in FIG. 1. The change in the arrangement of the magnetic cells 101b in the axial direction OD will be described with reference to FIGS. 3 to 6, and the change in the arrangement of the magnetic cells 101b in the axial direction AD will be described with reference to FIGS. 7 and 8. The changes in the arrangement of the magnetic cells 101b in the orthogonal direction OD and the axial direction AD may be combined. This allows the volume and/or weight of the magnetic material powder 11 per unit volume to be adjusted in the axis orthogonal direction OD and the axial direction AD, and the temperature of the honeycomb structure 1 during induction heating in the axis orthogonal direction OD and the axial direction AD can be adjusted.

As shown in FIG. 9, the central region 12 having the arrangement of the magnetic cells 101b as described above may be gradually reduced from one end face E1 to the other end face E2. As the central region 12 is reduced, the outer peripheral region 13 may be increased.

As shown in FIG. 10, the central region 12 having the arrangement of the magnetic cells 101b as described above is gradually reduced from one end face E1 to the intermediate position in the axial direction AD, and may be terminated at the intermediate position. That is, from the intermediate position to the other end face E2, such an arrangement mode of the magnetic cells 101b may not be provided. From the intermediate position to the other end face E2, the same arrangement mode of the magnetic cells 101b as that of the outer peripheral region 13 at the one end face E1 may be provided, but another arrangement mode of the magnetic cells 101b may also be provided. No magnetic cell 101b may be provided from the intermediate position to the other end face E2.

### Embodiment 2

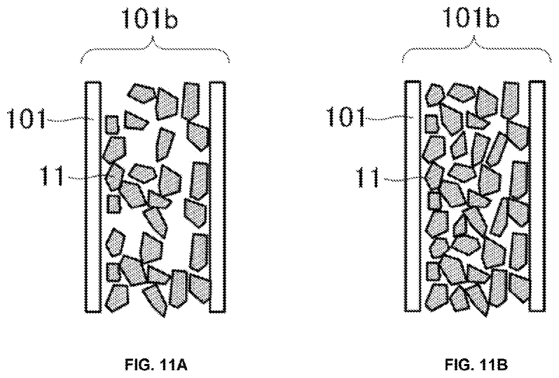

FIGS. 11A and 11B are explanatory views showing a main part of a honeycomb structure 1 according to Embodiment 2 of the present invention. The overall configuration of the honeycomb structure 1 according to Embodiment 2 is the same as that according to Embodiment 1, and reference may be made to FIGS. 1 to 10 for the descriptions.

Embodiment 1 has been described such that the volume and/or weight of the magnetic material powder 11 per unit volume is varied depending on the arrangement of the magnetic cells 101b. However, as shown in FIGS. 11A and 11B, the volume and/or weight of the magnetic material powder 11 per unit volume may be varied by changing a filling rate of the magnetic material powder 11 in the magnetic cells 101b. FIG. 11A shows a state where the filling rate of the magnetic material powder 11 is relatively low, and FIG. 11B shows a state where the filling rate of the magnetic material powder 11 is relatively high.

The honeycomb structure portion 10 may have a plurality of regions which are arranged coaxially with each other and have different filling rates of the magnetic material powder 11 in the magnetic cells 101b, at the end face or in the cross section orthogonal to the axial direction AD. In Embodiment 2, all the cells 101a may be the magnetic cells 101b, and the filling rate of the magnetic material powder 11 may be changed in the axis orthogonal direction OD, although not limited thereto. The filling rate can be determined by image analysis. More specifically, the measurement can be performed by taking a photograph of the cross section of the magnetic cell 101b with an optical microscope or a scanning electron microscope, capturing the image by an image analysis device, and determining a ratio of the magnetic material powder 11 and voids within the captured range.

The filling rate can be varied by changing the particle size distribution of the magnetic material powder 11 for each region. The filling rate tends to increase as the particle size of the magnetic material powder 11 increases. By using a mixture of the magnetic material powder 11 having a coarse particle size and the magnetic material powder 11 having a fine particle size, the filling rate can be further increased. The particle size of the magnetic material powder 11 may be in the range of 5 to 100 μm for D50 (median diameter).

As with Embodiment 1, the honeycomb structure portion 10 can include a central region 12 including an axial center 10c of the honeycomb structure portion 10 and an outer peripheral region 13 adjacent to an outer peripheral wall 100 (see FIG. 5). The filling rate of the magnetic material powder 11 in the central region 12 may be higher than that of the magnetic material powder 11 in the outer peripheral region 13.

It is preferable that a difference between the filling rate in the central region 12 and the filling rate in the outer peripheral region 13 is 10% or more. In other words, the filling rate in the central region 12 is preferably higher by 10% or more than the filling rate in the outer peripheral region 13. A higher amount of magnetic flux can be induced in the central region 12 when the difference between the filling rates is 10% or more. The difference between the filling rates is more preferably 20% or more, and even more preferably 30% or more.

The honeycomb structure portion 10 may have end faces spaced apart from each other in the axial direction AD or cross sections orthogonal to the axial direction AD, which have different filling rates of the magnetic material powder 11 in the magnetic cells 101b. That is, instead of changing the arrangement of the magnetic cells 101b as described with reference to FIGS. 7 to 10, the filling rate of the magnetic material powder 11 may be changed in the axial direction AD.

The filling rate of the magnetic material powder 11 on the one end face E1 side of the honeycomb structure portion 10 may be higher than the filling rate of the magnetic material powder 11 on the other end face E2 side. The temperature of the honeycomb structure 1 during induction heating in the axial direction AD can be more reliably adjusted. Other configurations are the same as those of Embodiment 1.

It should be noted that Embodiment 1 and Embodiment 2 may be combined for implementation. That is, the filling rate of the magnetic material powder 11 in the magnetic cells 101b may be changed in the axial direction AD and/or the axis orthogonal direction OD while adjusting the arrangement of the magnetic cells 101b as in Embodiment 1.

### Embodiment 3

The overall configuration of the honeycomb structure 1 according to Embodiment 3 is the same as that according to Embodiment 1, and reference may be made to FIGS. 1 to 10 for the descriptions. Embodiments 1 and 2 have been described such that the volume and/or weight of the magnetic material powder 11 per unit volume are varied to adjust the induction of the magnetic flux, and adjust the temperature of the honeycomb structure 1 in the axial direction AD and/or the axis orthogonal direction OD. However, using multiple types of magnetic material powders 11 having different magnetic permeabilities, the induction of magnetic flux may be adjusted, and the temperature of the honeycomb structure 1 in the axial direction AD and/or the axial direction OD during induction heating may be adjusted.

That is, in the honeycomb structure 1 according to Embodiment 3, multiple magnetic material powders 11 are used at different ratios in the axial direction AD and/or the axial direction OD of the honeycomb structure portion 10. For example, assuming that a first magnetic material powder having a first magnetic permeability and a second magnetic material powder having a second magnetic permeability are used and the first magnetic permeability is larger than the second magnetic permeability, the first magnetic material powder alone (100%) can be attached to or filled in the cells 101a, or the second magnetic material powder alone (100%) can be attached to or filled in the cells 101a, or the first magnetic material powder and the second magnetic material powder can be mixed at a predetermined ratio and attached to or filled in the cells 101a. At a position having a higher ratio of the first magnetic material powder used, the magnetic permeability is higher and a larger amount of magnetic flux is induced. The magnetic flux distribution can be arbitrarily designed by the distribution of the ratio of the multiple magnetic material powders 11 used, so that the temperature of the honeycomb structure 1 in the axial direction AD and/or the axis orthogonal direction OD can be adjusted during induction heating.

As with Embodiment 1, the honeycomb structure portion 10 can include a central region 12 including an axial center 10c of the honeycomb structure portion 10 and an outer peripheral region 13 adjacent to an outer peripheral wall 100 (see FIG. 5). The magnetic permeability of the magnetic material powder 11 in the central region 12 may be higher than that of the magnetic material powder 11 in the outer peripheral region 13. For example, the first magnetic material powder described above may be used alone in the central region 12 and the second magnetic material powder described above may be used alone in the outer peripheral region 13.

It is preferable that a difference between the magnetic permeability of the magnetic material powder 11 in the central region 12 and the magnetic permeability of the magnetic material powder 11 in the outer peripheral region 13 is 1000 or more. The difference between the magnetic permeabilities of 1000 or more can lead to induction of a larger amount of magnetic flux in the central region 12. The difference between the magnetic permeabilities is more preferably 1500 or more, and even more preferably 2000 or more.

The magnetic permeability of the magnetic material powder 11 on the one end face E1 side of the honeycomb structure portion 10 may be higher than that of the magnetic material powder 11 on the other end face E2 side. The temperature of the honeycomb structure 1 during induction heating in the axial direction AD can be more reliably adjusted. Other configurations are the same as those of Embodiment 1.

At least one of Embodiment 1 and Embodiment 2 may be combined with Embodiment 3 for implementation. That is, the ratio of the multiple magnetic material powders 11 used can be changed while adjusting the arrangement of the magnetic cells 101b as in the Embodiment 1 and/or changing the filling rate of the magnetic material powder 11 in the magnetic cells 101b as in Embodiment 2.

### Embodiment 4

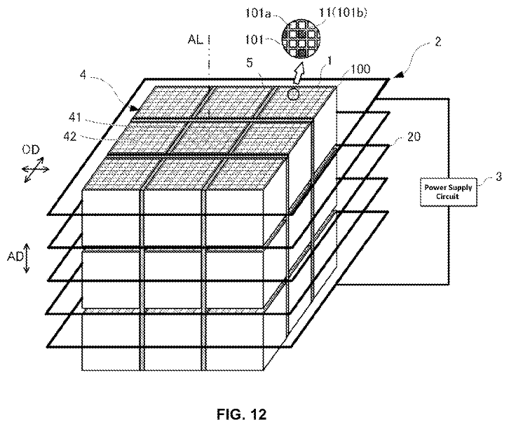

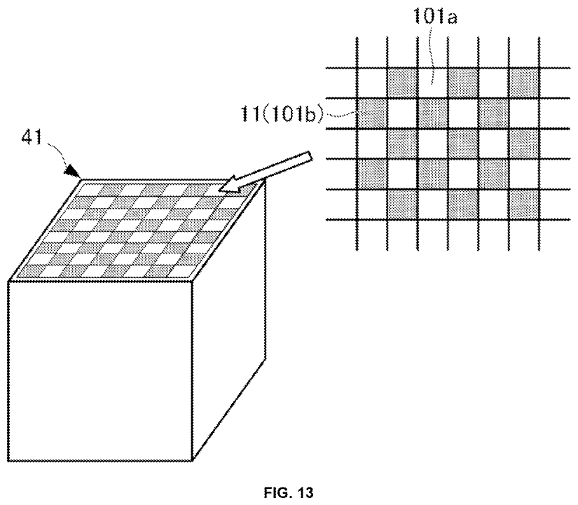

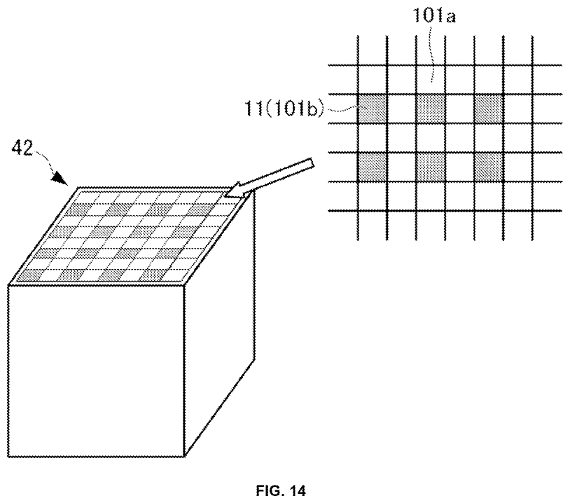

FIG. 12 is a perspective view showing an induction heating device provided with a honeycomb unit 4 according to Embodiment 4 of the present invention, FIG. 13 is a perspective view showing a central honeycomb structure 41 in FIG. 12, and FIG. 14 is a perspective view showing an outer peripheral honeycomb structure 42 in FIG. 12. While Embodiments 1 to 3 have been described for one honeycomb structure 1 and the induction heating device including the same, for example, in a large plant or the like, a honeycomb unit 4 in which a plurality of honeycomb structures 1 are combined and an induction heating device including the honeycomb unit 4 may be used. The present invention can also be applied to such a honeycomb unit 4 and induction heating device.

As shown in FIG. 12, the induction heating device according to this embodiment has a honeycomb unit 4, an induction heating coil 2 and a power supply circuit 3.

The honeycomb unit 4 includes a plurality of honeycomb structures 1 arranged side by side in their respective axial directions AD and/or axis orthogonal directions OD. The overall configuration of the honeycomb structure 1 is the same as that of Embodiments 1 to 3, and the descriptions thereof may refer to the descriptions of the present embodiment. That is, each of the plurality of honeycomb structures 1 includes an outer peripheral wall 100, and partition walls 101 that are arranged on an inner side of the outer peripheral wall 100, the partition walls 101 defining a plurality of cells 101a each forming a flow path extending from one end face to other end face.

As illustrated, the honeycomb structure 1 according to this embodiment has a pillar shape with rectangular end faces. In the illustrated embodiment, the honeycomb structures 1 are arranged side by side in the axial direction AD so that their end faces are opposed to each other. Also, the honeycomb structures 1 are arranged side by side in the axis orthogonal direction OD so that the respective outer peripheral walls 100 face each other. The axial direction AD and the axis orthogonal direction OD of the honeycomb structure 1 may be synonymous with the axial direction AD and the axis orthogonal direction OD of the honeycomb unit 4 as a whole.

The number of honeycomb structures 1 arranged in the axial direction AD and the axis orthogonal direction OD is arbitrary. In the illustrated embodiment, three sets of honeycomb structures 1 are arranged in the axial direction AD, each of the three sets being nine honeycomb structures 1 arranged in the axis orthogonal direction OD. A larger or smaller number of honeycomb structures 1 may be arranged in the axis orthogonal direction OD and/or the axial direction AD. For example, the number of honeycomb structures 1 arranged in the axis orthogonal direction OD or the axial direction AD may be one, such as three honeycomb structures 1 being arranged in the axial direction AD.

In each of the honeycomb structures 1, the volume and/or weight the magnetic material powder 11 per unit volume and the ratio of the magnetic material powder 11 used may be adjusted as described in Embodiments 1 to 3, but, in one honeycomb structure 1 according to Embodiment 4, the volume and/or weight of the magnetic material powder 11 per unit volume and the ratio of the magnetic material powder 11 used may be constant.

The honeycomb unit 4 may have a magnetic bodies or metals 5 arranged between the honeycomb structures 1. By arranging such magnetic bodies or metals 5, the heat radiation of the honeycomb unit 4 is suppressed, and the temperature of the central portion of the honeycomb unit 4 can be improved. In the illustrated embodiment, each of the magnetic bodies or metals 5 is formed in a flat plate shape and arranged between the outer peripheral walls 100 of the respective honeycomb structures 1. Each magnetic body or metal 5 may be adjacent to the outer peripheral wall 100 of each honeycomb structure 1. No magnetic body or metal 5 is arranged between the end faces of the respective honeycomb structures 1. The magnetic body or metal 5 may be omitted as a whole, and the outer peripheral walls 100 of the respective honeycomb structures 1 may be adjacent to each other.

The overall configuration of the induction heating coil 2 and the power supply circuit 3 is also the same as that of Embodiments 1 to 3, and the descriptions thereof may refer to the descriptions of the present embodiment. However, the induction heating coil 2 is arranged on the outer periphery of the honeycomb unit 4. An axis line AL of the induction heating coil 2 can be parallel to the axial direction AD of the honeycomb unit 4. The axis line AL may be coaxial with the central axis of honeycomb unit 4. By supplying alternating current from the power supply circuit 3 to the induction heating coil 2, magnetic flux is generated in the vicinity of the induction heating coil 2, and the magnetic flux from the induction heating coil 2 can induction-heat the honeycomb unit 4.

The honeycomb unit 4 according to the present embodiment is configured such that the volume and/or weight of the magnetic material powder 11 per unit volume is varied in the axial direction AD and/or the orthogonal direction OD of the honeycomb unit 4. The magnetic flux distribution can be arbitrarily designed by the distribution of the magnetic material powder 11, and the temperature of the honeycomb unit 4 in the axial direction AD and/or the axis orthogonal direction OD during induction heating can be adjusted. That is, in the honeycomb unit 4 of the present embodiment, the temperature distribution of the honeycomb unit 4 can be made uniform, and an intentional temperature deviation can be generated.

In the honeycomb unit 4 according to the present embodiment, the ratio of the magnetic cells 101b present may be varied for each honeycomb structure 1 arranged in the axis orthogonal direction OD. By thus varying the ratio of the magnetic cells 101b present, the volume and/or weight of the magnetic material powder 11 per unit volume in the axis orthogonal direction OD can be adjusted, and the temperature of the honeycomb unit 4 in the axis orthogonal direction OD during induction heating can be adjusted.

The method of adjusting the volume and/or weight of the magnetic material powder 11 per unit volume in the axis orthogonal direction OD that can be used herein includes, but not limited to, a method of varying the number of the magnetic cells 101b included in the cell blocks 101c having the same size for each honeycomb structure 1 (the method described with reference to FIGS. 3A and 3B), and/or a method of varying the size of the cell blocks 101c each including one magnetic cell 101b for each honeycomb structure 1 (the method described with reference to FIGS. 4A-4C).

As shown in FIG. 12, the honeycomb unit 4 includes a central honeycomb structure 41 arranged at a position including an axis center of the honeycomb unit 4 and an outer peripheral honeycomb structure 42 arranged at a position forming an outer edge of the honeycomb unit 4. The ratio of the magnetic cells 101b present in the central honeycomb structure 41 may be larger than that of the magnetic cells 101b present in the outer honeycomb structure 42, although not particularly limited thereto. This mode is particularly useful when it is desired to induce more magnetic flux to the central honeycomb structure 41 and increase the temperature of the central honeycomb structure 41. FIGS. 13 and 14 show an example in which the magnetic cells 101b are arranged more densely in the central honeycomb structure 41 than in the outer peripheral honeycomb structure 42.

Although not shown, between the central honeycomb structure 41 and the outer peripheral honeycomb structure 42 may be an intermediate honeycomb structure having a different ratio of the magnetic cells 101b present from those of the central honeycomb structure 41 and the outer peripheral honeycomb structure 42. The ratio of the magnetic cells 101b present in the intermediate honeycomb structure may be smaller than that of the magnetic cells 101b present in the central honeycomb structure 41 and larger than that of the magnetic cells 101b in the outer peripheral honeycomb structure 42, although not particularly limited thereto. When two or more intermediate honeycomb structures arranged side by side in the axis orthogonal direction OD are provided between the central honeycomb structure 41 and the outer peripheral honeycomb structure 42, the ratio of the magnetic cells 101b present in the intermediate honeycomb structure on the inner side may be larger than that of the magnetic cells 101b present in the intermediate honeycomb structure on the outer side.

In the honeycomb unit 4, the number of the magnetic cells 101b per unit area may be varied for each honeycomb structure 1 arranged in the axis orthogonal direction OD. The number of the magnetic cells 101b adjacent to each other may be varied for each honeycomb structure 1. The number of the magnetic cells 101b per unit area in the central honeycomb structure 41 may be larger than that of the magnetic cells 101b per unit area in the outer peripheral honeycomb structure 42.

In the honeycomb unit 4, the ratio of the magnetic cells 101b present or the number of the magnetic cells 101b per unit area (the ratio of the magnetic cells 101b present or the like) may be varied for each of the honeycomb structures 1 arranged side by side in the axial direction AD. For example, in FIG. 12, the ratio of the magnetic cells 101b present or the like of the middle honeycomb structure 1 may be larger than the ratio of the magnetic cells 101b present or the like of the upper and lower honeycomb structures 1.

Further, as with Embodiment 2, in the honeycomb unit 4, the filling rate of the magnetic material powder 11 in the magnetic cells 101b may be varied for each of the honeycomb structures 1 arranged side by side in the axial orthogonal direction OD. The filling rate of the magnetic material powder 11 in the central honeycomb structure 41 may be higher than that of the magnetic material powder 11 in the outer peripheral honeycomb structure 42. It is preferable that a difference between the filling rates in the central honeycomb structure 41 and the outer peripheral honeycomb structure 42 is 10% or more.

Moreover, in the honeycomb unit 4, the filling rate of the magnetic material powder 11 in the magnetic cells 101b may be varied for each of the honeycomb structures 1 arranged side by side in the axial direction AD. The filling rate of the honeycomb structure 1 on one end side in the axial direction AD may be higher than that of the honeycomb structure 1 on the other end side.

Further, as with Embodiment 3, the ratio of the multiple magnetic material powders 11 used may be different in the axial direction AD and/or the axis orthogonal direction OD of the honeycomb unit 4. The magnetic permeability of the magnetic material powder 11 of the central honeycomb structure 41 may be higher than that of the magnetic material powder 11 of the outer peripheral honeycomb structure 42. The difference between the magnetic permeability of the magnetic material powder 11 of the central honeycomb structure 41 and the magnetic permeability of the magnetic material powder 11 of the outer peripheral honeycomb structure 42 is preferably 1000 or more. The magnetic permeability of the magnetic material powder 11 of the honeycomb structure 1 on one end side in the axial direction AD may be higher than that of the magnetic material powder 11 of the honeycomb structure 1 on the other end side. Other configurations are the same as those of Embodiments 1 to 3.

The present invention is not limited to each embodiment, and can be embodied by modifying the components without departing from the spirit of the present invention. Moreover, various inventions can be created by appropriately combining a plurality of components disclosed in each embodiment. For example, some components may be deleted from all the components shown in the embodiments. Furthermore, components of different embodiments may be combined as appropriate.

### Examples

A honeycomb structure 1 was produced as follows. In a raw material mixing step, first, a cordierite forming raw material was prepared as a ceramic raw material. Specifically, talc, kaolin, calcined kaolin, alumina, aluminum hydroxide, and quartz were mixed to prepare the cordierite forming raw material. To the cordierite forming material were added methyl cellulose and hydroxypropoxyl methyl cellulose as binders, a surfactant, and water to obtain a forming raw material, which was then mixed to obtain a green body. Subsequently, in a forming step, the green body was extruded using a predetermined die to form a honeycomb formed body having the shape of partition walls forming square cells. In addition, the part which would become the outer peripheral portion was integrally formed. Then, the obtained honeycomb formed body was dried and then fired in a firing step. The drying was carried out in a microwave dryer for 10 to 30 minutes, the firing was maintained at a maximum temperature of 1430° C. for 5 to 15 hours, and was carried out for 40 to 60 hours in total to obtain the honeycomb structure 1. The obtained honeycomb structure 1 had an end surface diameter of 82 mm, an axial length of 85 mm, and a cell structure of 4 mil/400 cpsi.

The cells 101a in each region of the obtained honeycomb structure 1 were filled with Fe-18Cr powder by the method as shown in Table 1 below, and heat-treated in a vacuum atmosphere at 1200° C. to produce Examples 1 to 8, and Comparative Examples 1 and 2.

The heat-treated honeycomb structure 1 was placed in a quartz glass tube having a diameter of 90 mm. An induction heating coil 2 made by winding a copper pipe having a diameter of 100 mm three times was arranged around on the outer periphery of the quartz glass tube. Then, under the conditions of a power of 4 kW, a frequency of 100 kHz, and air at room temperature at a flow rate of 0.45 m 3/min, the induction heating was performed for 180 s by passing air through the quartz glass tube, and the maximum temperature of the center of the honeycomb structure 1 (the center in the longitudinal direction and the axial direction) was measured with a thermocouple. The results are also shown in Table 1 below.

TABLE 1

| | | Ratio of Magnetic | | | Max. Temp. |
|---|---|---|---|---|---|
| | Region | Cells Present | | Magnetic Material Powder | (° C.) |
| Example 1 | Center-41 mm | 1/16 | cells | Fe—18Cr Material | 350 |
| | 41 mm-82 mm | 1/25 | cells | Same as above | |
| Example 2 | Center-62 mm | 1/16 | cells | Same as above | 280 |
| | 62 mm-82 mm | 1/25 | cells | Same as above | |
| Example 3 | Center-41 mm | 1/9 | cells | Same as above | 530 |
| | 41 mm-82 mm | 1/25 | cells | Same as above | |
| Example 4 | Center-41 mm | 1/9 | cells | Same as above | 570 |
| | 41 mm-61 mm | 1/16 | cells | Same as above | |
| | 61 mm-82 mm | 1/25 | cells | Same as above | |
| Example 5 | Center-41 mm | 4/25 | cells | Same as above | 450 |
| | 41 mm-82 mm | 1/25 | cells | Same as above | |
| Example 6 | Center-41 mm | 1/25 | cells | Fe—18Cr Material with D50 = 10 μm | 450 |
| | 41 mm-82 mm | 1/25 | cells | Fe—18Cr Material with D50 = 60 μm | |
| Example 7 | Center-41 mm | 1/25 | cells | Fe—18Cr Mixed Material with | 500 |
| | | | | D50 = 10 μm and 60 μm | |
| | 41 mm-82 mm | 1/25 | cells | Fe—18Cr Material with D50 = 60 μm | |
| Example 8 | Center-41 mm | 1/25 | cells | Fe—49Co—2V Mixed Material with | 500 |
| | | | | Permeability μ = 4700 | |
| | 41 mm-82 mm | 1/25 | cells | Fe—18Cr Material with | |
| | | | | Permeability μ = 1000 | |
| Comp. 1 | Center-82 mm | 1/25 | cells | Fe—18Cr Material | 220 |
| Comp. 2 | Center-82 mm | 1/16 | cells | Fe—18Cr Material | 180 |

In Table 1, for example, the notation “Center-41 mm” refers to a region of a circle having a diameter of 41 mm where the axial center at the end face or in the cross section orthogonal to the axial direction AD was the center, and “41 mm-82 mm” refers to an annular region between the circle having the diameter of 41 mm and the outer edge of the honeycomb structure 1. Also, for example, the notation “1/25 cells” indicates that one magnetic cell 101b exists in a range of 5 cells×5 cells. The notation of “4/25 cells” in Example 5 indicates that there are magnetic cells 101b having a size of 2 cells×2 cells in a range of 5 cells×5 cells.

In Comparative Examples 1 and 2, the magnetic cells 101b are evenly arranged in the radial direction, whereas in Examples 1 to 8, the ratio of the magnetic cells 101b present was changed in the radial direction. As shown in Table 1, it was found that by changing the ratio of the magnetic cells 101b present as in Examples 1 to 8, the induction of magnetic flux can be adjusted, and the maximum temperature at the center of the honeycomb structure 1 can be changed. Especially, in Examples 1 to 8, the maximum temperature is higher than in Comparative Examples 1 and 2. This would be because the ratio of the magnetic cells 101b present in the central region 12 is higher than the ratio of the magnetic cells present in the outer peripheral region 13.

### DESCRIPTION OF REFERENCE NUMERALS

1: honeycomb structure
10: honeycomb structure portion
100: outer peripheral wall
101: partition wall
101a: cell
101b: magnetic cell
101c: cell block
11: magnetic material powder
12: central region
13: outer peripheral region

1. A honeycomb structure comprising:
a honeycomb structure portion comprising an outer peripheral wall and partition walls arranged on an inner side of the outer peripheral wall, the partition walls defining a plurality of cells each forming a flow path extending one end face to other end face; and
a magnetic material powder attached to or filled in at least one of the plurality of cells,
wherein a volume and/or weight of the magnetic material powder per unit volume vary in an axial direction and/or an axis orthogonal direction of the honeycomb structure portion.

2. The honeycomb structure according to claim 1,
wherein the plurality of cells comprise a plurality of magnetic cells having the magnetic material powder filled in the cells or having the magnetic material powder attached to the partition walls, and
wherein the honeycomb structure portion has a plurality of regions which are arranged coaxially with each other and have different ratios of the magnetic cells present from each other, at the end face or in a cross section orthogonal to the axial direction.

3. The honeycomb structure according to claim 2,
wherein the axis orthogonal direction comprises first and second directions that intersect with each other, and
wherein the cells having a certain number, adjacent to each other, comprise cell blocks each including X cells each in the first and second directions, where X is any positive number, and
wherein the magnetic cells included in the cell blocks having the same size have different numbers from each other between the plurality of regions.

4. The honeycomb structure according to claim 2,
wherein the axis orthogonal direction comprises first and second directions that intersect with each other,
wherein the cells having a certain number, adjacent to each other, comprise cell blocks each including X cells each in the first and second directions, where X is any positive number, and
wherein the cell blocks each including one magnetic cell have different sizes from each other between the plurality of regions.

5. The honeycomb structure according to claim 2,
wherein the honeycomb structure portion comprises: a central region including an axial center of the honeycomb structure portion; and an outer peripheral region adjacent to the outer peripheral wall, and
wherein a ratio of the magnetic cells present in the central region is larger than that of the magnetic cells present in the outer peripheral region.

6. The honeycomb structure according to claim 1,
wherein the plurality of cells comprise a plurality of magnetic cells having the magnetic material powder filled in the cells or having the magnetic material powder attached to the partition walls, and
wherein the honeycomb structure portion has a plurality of regions which are arranged coaxially with each other and have different numbers of the magnetic cells per unit area from each other, at the end face or in the cross section orthogonal to the axial direction.

7. The honeycomb structure according to claim 6, wherein the magnetic cells adjacent to each other have different numbers between the plurality of regions.

8. The honeycomb structure according to claim 6,
wherein the honeycomb structure portion comprises: a central region including an axial center of the honeycomb structure portion; and an outer peripheral region adjacent to the outer peripheral wall, and
wherein the number of the magnetic cells per unit area in the central region is larger than that of the magnetic cells per unit area in the outer peripheral region.

9. The honeycomb structure according to claim 1,
wherein the plurality of cells comprise a plurality of magnetic cells having the magnetic material powder filled in the cells, and
wherein the honeycomb structure portion has the end faces axially spaced from each other or cross sections orthogonal to the axial direction, the end faces or the cross sections having different ratios of the magnetic cells present or different numbers of the magnetic cells per unit area from each other.

10. The honeycomb structure according to claim 1,
wherein the plurality of cells comprise a plurality of magnetic cells having the magnetic material powder filled in the cells, and
wherein the honeycomb structure portion has a plurality of regions which are arranged coaxially with each other and have different filling rates of the magnetic material powder in the magnetic cells from each other, at the end face or in the cross section orthogonal to the axial direction.

11. The honeycomb structure according to claim 10,
wherein the honeycomb structure portion comprises: a central region including an axial center of the honeycomb structure portion; and an outer peripheral region adjacent to the outer peripheral wall, and
wherein the filling rate of the magnetic material powder in the central region is higher than that of the magnetic material powder in the outer peripheral region.

12. The honeycomb structure according to claim 11, wherein a difference between the filling rates in the central region and the outer peripheral region is 10% or more.

13. The honeycomb structure according to claim 1,
wherein the plurality of cells comprise a plurality of magnetic cells having the magnetic material powder filled in the cells, and
wherein the honeycomb structure portion has the end faces axially spaced from each other or cross sections orthogonal to the axial direction, the end faces or the cross sections having different filling rates of the magnetic material powder in the magnetic cells from each other.

14. The honeycomb structure according to claim 13, wherein the filling rate of the magnetic material powder on the one end face side of the honeycomb structure portion is higher than that of the magnetic material powder on the other end face side.

15. A honeycomb structure comprising:
a honeycomb structure portion having an outer peripheral wall and partition walls arranged on an inner side of the outer peripheral wall, the partition walls defining a plurality of cells each forming a flow path extending from one end face to other end face; and
a magnetic material powder attached to or filled in at least one of the plurality of cells,
wherein the magnetic material powder comprises multiple magnetic material powders having different magnetic permeabilities, and
wherein a ratio of the multiple magnetic material powders used varies in an axial direction and/or an axis orthogonal direction of the honeycomb structure portion.

16. The honeycomb structure according to claim 15,
wherein the honeycomb structure portion comprise: a central region including an axial center of the honeycomb structure portion; and an outer peripheral region adjacent to the outer peripheral wall at the end face or in a cross section orthogonal to the axial direction, and
wherein the magnetic material powder in the central region has a larger magnetic permeability than that of the magnetic material powder in the outer peripheral region.

17. The honeycomb structure according to claim 16, wherein a difference between the magnetic permeabilities of the magnetic material powders in the central region and the outer peripheral region is 1000 or more.

18. A honeycomb unit comprising:
a plurality of honeycomb structures, each having an outer peripheral wall and partition walls arranged on an inner side of the outer peripheral wall, the partition walls defining a plurality of cells each forming a flow path extending from one end face to other end face, the honeycomb structures being arranged side by side in respective axial directions and/or axis orthogonal directions; and
a magnetic material powder attached to or filled in at least one of the plurality of cells in at least one of the honeycomb structures,
wherein a volume and/or weight of the magnetic material powder per unit volume vary in the axial direction and/or the axis orthogonal direction of the honeycomb unit.

19. A honeycomb unit comprising:
a plurality of honeycomb structures, each having an outer peripheral wall and partition walls arranged on an inner side of the outer peripheral wall, the partition walls defining a plurality of cells each forming a flow path extending from one end face to other end face, the honeycomb structures being arranged side by side in respective axial directions and/or axis orthogonal directions; and
a magnetic material powder attached to or filled in at least one of the plurality of cells in at least one of the honeycomb structures,
wherein the magnetic material powder comprises multiple magnetic material powders having different magnetic permeabilities, and
wherein a ratio of the multiple magnetic material powders used varies in the axial direction and/or the axis orthogonal direction of the honeycomb unit.

20. The honeycomb unit according to claim 18, wherein a magnetic body or metal is disposed between the honeycomb structures.

21. The honeycomb unit according to claim 19, wherein a magnetic body or metal is disposed between the honeycomb structures.

22. An induction heating device, comprising:
the honeycomb structure according to claim 1; and
an induction heating coil arranged around an outer periphery of the honeycomb structure or the honeycomb unit, the induction heating coil heating the honeycomb structure or the honeycomb unit by induction heating.

23. An induction heating device, comprising:
the honeycomb structure according to claim 15; and
an induction heating coil arranged around an outer periphery of the honeycomb structure or the honeycomb unit, the induction heating coil heating the honeycomb structure or the honeycomb unit by induction heating.

24. An induction heating device, comprising:
the honeycomb unit according to claim 18; and
an induction heating coil arranged around an outer periphery of the honeycomb structure or the honeycomb unit, the induction heating coil heating the honeycomb structure or the honeycomb unit by induction heating.

25. An induction heating device, comprising:
the honeycomb unit according to claim 19; and
an induction heating coil arranged around an outer periphery of the honeycomb structure or the honeycomb unit, the induction heating coil heating the honeycomb structure or the honeycomb unit by induction heating.
